(19) United States
(12) Patent Application Publication
(10) Pub. No.: US 2007/0248938 A1
(43) Pub. Date: Oct. 25, 2007

(54) Method for teaching reading using systematic and adaptive word recognition training and system for realizing this method.

(75) Inventor: Simon Paul Ronald, Adelaide (AU)

Correspondence Address: ROCKETREADER PTY LTD., LEVEL 2, 25 GRESHAM STREET, ADELAIDE, 5000, AU

(73) Assignee: ROCKETREADER PTY LTD, Adelaide (AU)

(21) Appl. No.: 11/307,228

(22) Filed: Jan. 27, 2006

(51) Int. Cl. G09B 17/00; G09B 7/00

(52) U.S. Cl. 434/178; 434/327; 704/231

(57) ABSTRACT

A method for teaching a child to read based on the training of a set of words or phrases whereby the past comprehension history of that child for each of the words and phrases is used to formulate a specific presentation, teaching and assessment strategy which will vary from word to word and phase to phrase, with the objective of teaching the child to read and recognize new words and phrases while at the same time consolidating the recognition of better understood words and phrases in order to reduce the onset of poor reading habits such as word vocalization, eye overuse and eye skip back (regression). The interactive reading tutor application may be access locally or remotely accessed by users via a network such as the Internet. This invention can also be used to train adults with poor reading skills, readers with reading disorder, and persons learning a second or subsequent language. The invention may be used to teach languages other than English.

### BACKGROUND OF THE INVENTION

The present relates to systems and methods for teaching a child to read and improve reading speed and fluency through the use of a computer program that teaches both word recognition and an efficient reading style.

### DESCRIPTION OF THE BACKGROUND

A study of American 8th graders by the US Department of Education in 1998 found that 66% of students were unable to summarize what they read. Although they averaged over 21 hours a week watching television, the time spent reading was less than 2 hours a week. In 1991, 40% of all households did not buy a single book. Such trends spurred the US Congress in 1997 to establish a National Reading Panel (NRP) to explore recommendations for effective instructional techniques in reading. This panel comprised 14 people, including leading scientists in reading research, educators, teachers, and parents. This panel distilled the results of 100,000 research studies carried out on reading since 1966 into a comprehensive report. The NRP's report is thought of as the most influential documents on reading instruction to date.

Children who read well are building a bridge to a successful future. Reading well often translates to reading and learning more, and getting better grades in school, college and university. Children who enjoy reading are often more inclined to read after hours and during the weekend. Children who read slowly and with difficulty are trapped in another world; the world of the ‘slow reader’. They find reading a tiring, difficult and laborious task. As a result, they only read what is absolutely necessary at school and are unlikely to read after hours. [Timothy Bell. Extensive reading: Speed and comprehension. The Reading Matrix, 1(1), 2001]. In addition, they often have low confidence when reading. Children who fall behind in their reading, fall further behind later on in life. A study by the National Institute of Child Health and Human Development found the majority of children who had reading problems in the third grade continued to have problems in the ninth grade. Children with reading problems often grow up to become adults with reading difficulties [R. Klassen. ‘After the statement’: Reading progress made by secondary students with specifics literacy difficulty provision. Educational Psychology in Practice., 17:121-133, 2001.]. Children who read poorly are often assumed to be lazy. A child who reads slowly and with difficulty is often expending around four times more visual and mental effort to read the same amount of information as a child who reads well. When consider work is put into an activity and little is derived from it, tiredness and frustration arises. These conditions make it very difficult for children to persevere and improve.

Children are under considerable pressure. By the second and third grade, they are already expected to read storybooks fluently and comprehend what they read. If a child can see they are not as fluent as their peers, they can quickly become demoralized. This compounds the problem and can perpetuate a repeating cycle of low confidence in reading, and in life.

Hence, children often become segregated into two different worlds: the world of the slow reader; and the world of the fast, accurate and high stamina reader. Good reading instruction helps children develop good reading skills, boosting reading confidence so they do not become ensnared in the world of the slow reader. A child who receives solid reading instruction is equipped to accept the future challenges of extensive online and electronic reading.

This patent presents a new method for teaching a child to read using a computer program which uses a method that seamlessly unifies accepted methods of reading instruction with methods that eliminate bad reading habits early in the reading tuition process.

The assignee of this Patent has been selling high performance reading software, RocketReader (www.rocketreader.com), since 1996. The RocketReader software since its inception has gained considerable worldwide support having thousands of customers in many countries, primarily in the USA, UK, Europe, Japan, Australia and New Zealand. This commercial interest highlights the demand for reading software that trains for reading fluency and breaks bad reading habits. The RocketReader software only targets the age range seven years old and older. However, since 1996 RocketReader has received many requests for a new computer-based instructional method that is effective for children learning to read, especially in the age group 3 to 7. This grass-roots demand, and a five year review of child reading-instructional techniques, along with the feedback resulting from 10 years of feedback from the customers of the RocketReader reading proficiency software has provided the motivation and background for this invention.

In reviewing the prior art related to reading tuition, it is important to summarize the various theories on the neural process of reading. Numerous models of reading exist in the scientific literature. These include:
(1) Word shape[Oscar de Bruijn and R. Spence. Rapid serial visual presentation: A space-time trade-off in information presentation. In AVI '00: Proceedings of the working conference on Advanced visual interfaces, pages 189-192. ACM Press, 2000.]. The pattern of ascending and descending strokes forms a word boundary. The word is identified by this outline and the context in which it appears. While this model of reading is still popular with some typographers, it is generally considered outdated by most researchers [E. Matin. US patent. sequential rapid communication visual displays. U.S. Pat. No. 4,845,645, Jul. 4, 1989.]
(2) The serial letter recognition model [Elizabeth Hanson-Smith. Reading electronically: Challenges and responses to the reading puzzle in technologically enhanced environments. The Reading Matrix, 3(3), 2003]. A model where words are read from left to right, letter by letter in a serial fashion. This was proposed as a simplified model of reading. The process is similar to a word lookup in a dictionary; one locates the first letter and then proceeds to successive letters until the word is located. This model of reading is considered primitive and outdated by most reading researchers.
(3) The parallel letter recognition model [E. Matin. US patent. sequential rapid communication visual displays. U.S. Pat. No. 4,845,645, Jul. 4, 1989.]. This is the most modern model of reading. This model works as follows: The eyes gaze upon a chunk of text, and the signals reach the brain. Features are then extracted from the lines and shapes. Individual letters are classified in a semi-simultaneous fashion (in parallel). Then the individual letters trigger different neural word classifiers—the word classifier that receives the strongest signal prevails and the word is named. This model describes the letters within the territory of one eye fixation being classified at the same time in parallel by the brain. The labeling of the words occurs as a dynamic process until the strength of the label is sufficiently high. For example, the word rats may be prematurely (and partially) labeled during the dynamic parallel letter recognition phase as ‘ruts’, ‘rots’, ‘rate’, ‘bats’, and ‘rats’ until the neurons telegraph that ‘rats’ has the highest signal.

The parallel model of reading, which has the most scientific support by modern researchers, suggests that we do not read left to right in a letter-by-letter serial fashion. Rather, we look at a chunk of text in a single eye fixation, and each letter in that text is recognized in parallel at the same time until the word or words in the text are fully labeled by the brain. For the slower reader, this process of decoding the words and then associating meaning takes considerable time and effort involving many chunks (fixation). This results in reduced speed and comprehension [K. Rayner. Eye movements in reading and information processing: 20 years of research. Psychological Bulletin, 124(3):372-422, 1998.].

Despite the considerable evidence that the brain reads information in parallel a chunk at a time, the traditional process of reading tuition has not fully exploited this scientific perspective. Reading tuition has polarized into two distinct instructional styles of phonetic or “letter by letter” reading instruction, or “whole of word (look/say) reading instruction”. We discuss the strengths and pitfalls of both approaches.

Phonics-based instructional techniques train the student to read, pronounce and understand the word from first principles using a method of the child saying out each letter, and blending letters to form sounds until they can create the sound of the word in a left to right fashion until they can hear the word and therefore create a meaning and understand it. The method of phonics has some heavyweight backing including strong support from the findings of the National Panel of Reading and the International Reading Association. Backers of this method of reading instruction believe that a direct, sequential method of teaching enables students to learn to read in a rapid and organized fashion. This method of reading is highly effective as an initial instructional method. However, a transition to a more fluid style that promotes the parallel letter recognition mechanism that the brain is capable of is required. A student who employs letter by letter reading alone must graduate to whole word recognition or they will become slow readers in adult life. Most part-word reading instructional techniques do not adequately train for whole word recognition. Some readers will pick up the whole-word reading skills and will go on to be excellent readers without any further instruction or assistance. However, a disturbing proportion of these students will crystallize the techniques learned during this instructional phase and not advance to whole-word reading; this will follow them through to their adult life and they will be poor readers.

The instructional technique of “look-say” was very popular from around 1940 to 1970. The most modern neural understanding of reading suggests that the brain is capable of reading and labeling a chunk of words simultaneously and in parallel, and it has the biological hardware and the capability is present to achieve this. So, there is support for this method where it teaches the child to see a word and instantly comprehend its meaning. However, many children find that “look-say” instructional techniques do not work effectively as a mechanism to efficiently learn reading beyond a very basic level. For these children, the gap between not recognizing a word, to recognizing the entire word is too great as there is no intermediate hinting and manual decoding phase present. This method is somewhat embedded in “whole language” technique described next.

Instructional techniques that use “whole language” recognition strategies have gained considerable popularity since around 1990. This method of instruction relies on the pervasive presentation of language throughout many areas of the curriculum, children's literature, communication activities and writing activities as an effective exposure-based method of teaching reading.

In the classroom, teachers are now increasingly using phonics as one component of a whole language program. To supplement the groundswell of manual teaching methods integrating the two techniques, there is now an urgent need for a new computerized instructional method that exploits the strengths of phonetics and the transition to whole word reading. However there has been a technological and methodological barrier hindering such a fusion. At what point do we transition from part-word reading to whole word and multi-word reading? This patent presents methods that solve this conundrum by recognizing the complexity of the reading problem at a deeper level. Most reading instructional techniques assume that the process of learning to read a word such as “that” should be the same as the process to learn to read a word such as “thaw”. The word “that” is the 10th most popular word (by some reckonings) in the American language and occurs much more frequently in the American language than “thaw”. A child learning to read will be ready to train for “whole word” reading for this specific word “that” at a very early stage due to increased familiarly and exposure to this commonly appearing word. An optimal method for reading training should take into account every word that the student has heard as well as possessing a perfect model of how well the student understands and perceives each of those words. While the optimal reading tutor is likely to be impractical, it is possible to devise instructional methods that get closer to optimal reading tuition than prior art. Imagine a radically new system of reading instruction that tracks reading ability on individual words, and then uses this information to train the student using a strategy that is dynamically adapted for best training results for each word. Furthermore, imagine a process that trains to read in a way that accelerates phonetic reading into whole word reading and eliminates poor reading habits at an early stage in the reading process. A new process to achieve this is presented in this patent. But first, further detail is appropriate regarding poor reading habits.

The Overworked Eye

Reading does not occur when the eyes are moving. Vision transfer occurs when the eyes stop during the fixation phase. The fixation phase of the eye is approximately a quarter of a second for natural reading [I. S. Kirsch, A. Jungeblut, L. Jenkins, and Kolstad K Executive summary from adult literacy in America: A first look at the results of the National Adult Literacy Survey. U.S. Department of Education, Washington, D.C., 1993.].

High speed eye tracking camera studies have shown that in a slow reader, the eyes move and stop up to five times more than is necessary to assimilate the information as compared to a fast reader. Eye overwork occurs when reading a sentence requires excessive eye movements and eye fixations. The eyes perform considerable work for little information.

As an example, consider the following sentence “Our biggest expansion opportunity will come from volume licencing in Japan.”

A slow reader may move their eyes across the following sentence as follows. Each fixation is represented symbolically by a left and right parenthesis pair.

(our) (big)(gest) (ex)(pan)(sion) (op)(port)(tunity) (will) (come) (from) (vol)(ume) (lic)(en)(cing) (in) (Jap)(an).

This reading example describes 20 eye movements and 20 eye fixations i.e. 40 different eye operations. This considerable eye work is one reason that slow readers get tired. Increased ocular and mental workload often leads to poor comprehension.

Many studies have shown that better readers read the text in bigger chunks—this means fewer eye operations in order to read and understand the same amount of text as compared with a slower reader.

A fast reader may read the sentence as shown below:

“(our biggest expansion) (opportunity will come) (from volume licensing) (in Japan)”

Reading this text takes a proficient reader four eye movements, four eye fixations, and eight eye operations. This is five times less work than a slow reader, requiring much less effort, with better speed and higher comprehension resulting.

Readers will struggle with very small and frequent fixations often have worse reading comprehension because they may have forgotten the ideas in the first half of the sentence by the time they read the second half.

Skipback

During normal reading, the eye moves forward, on average, a distance of eight letters during each eye movement. However, this forward movement only occurs nine out of ten times for the average reader. The other ten percent of the time, the eyes skip back or regress to earlier words. This typically occurs for less familiar words or during sentence components that contain semantic ambiguity. Skip back is a significant problem in slower readers as behaves like speed bumps, interrupting the flow of reading.

Vocalization

There are two different methods to read words. The first is a direct lookup method where the brain identifies the meaning of the words through a whole word-recognition process. The second method is a vocal-assisted lookup where different parts of the word are sounded aloud or silently until the meaning of the word is determined. It has been shown that the average reader often employs a combination of these two methods when reading. Furthermore, it is thought that both mechanisms race together to find the meaning of the word.

Vocalization is a widespread reading habit that has the effect of limiting reading speed and comprehension. It occurs when we say the words we are reading out aloud with visible movements of the jaw. Verbal sounding of word parts is how many learn to read due to exposure to phonetic reading tuition during childhood. Vocalization and reading text out loud is an effective method of learning to read, but can form a significant habitual obstacle to reading faster. The explanation of this stems from the speed of speech. The average speaking speed is around 125 words per minute. Around 72 muscles must move to produce speech. Speaking speed is significantly slower than the average reading speed of 230 words per minute, and much slower than a proficient reader who reads accurately at a rapid 500 words per minute. The top speaking speed is around 300 words per minute, but few can maintain the concentration and considerable effort required to speak this quickly. It is clear that one can read faster when reading silently as compared to verbally. A transformation from a talking reader to a silent reader is pivotal in reading faster. Poor reading habits, such as vocalization, are common in both children and adults and they are difficult to remove. Many adults, while being literate, have never migrated to this next reading stage and often vocalize.

A reader who vocalizes has to make a big mechanical reading effort to extract a small amount of information. The slow pace of reading and poor level of comprehension resulting can make reading a frustrating exercise. There are many suggested practical strategies to eliminate vocalization [Timothy Bell. Extensive reading: Speed and comprehension. The Reading Matrix, 1(1), 2001.], however these exercises are aimed only at the adult reader.

Previous Work

Software programs such as RocketReader (rocketreader.com developed by the assignee of this patent), released in 1996, provide exercises to eliminate these bad habits in adult readers. These exercises are designed to ensure that text read earlier is not visible to the user and other methods such as rapid text display and the revealing of groups of words in a paced fashion. From its inception in 1996, RocketReader was designed with this scientific understanding of the parallel model of reading as its basis. The various exercises, including the flash, speed and group training exercises, train the user to increase text decoding efficiency, freeing up more cognitive resources for the reader to absorb meaning. RocketReader's chief training goal is to develop reading speed, comprehension and stamina by training the user to read more efficiently in chunks. It achieves this by increasing the number of letters recognized in a single eye fixation (chunk), by increasing the speed at which the information in a single eye fixation is processed, and by improving the speed and smoothness of the transition between one eye fixation and the next. However, the RocketReader software only trains to eliminate bad habits for individuals who already know how to read and the quoted target audience for RocketReader is ages seven to professional. The methodology and techniques for effectively eliminating bad habit onset in younger pre-readers has been an important but unresolved area of reading instruction. This invention details innovations for pre-readers and early readers who are typically younger than seven.

### FIELD OF THE INVENTION

This invention relates generally to a method for teaching children to read using a method to eliminate the onset of poor reading habits and to facilitate excellent reading speed and comprehension. Specifically, the invention teaches a series of computer controlled exercises designed to teach whole-word recognition, phonetic reading skills, typing skills, and phonetic awareness skills.

### THE STATE OF THE ART

The state of the art abounds with various techniques and methods which claim to improve a person's reading speed comprehension during training with those techniques. These methods are generally taught to adults as a instructor-led course, a book or manual, or as a recorded course, or as a computer-based application.

Speed reading exercises and techniques are also trained using computer software. A computerized tachistoscopeis presented in U.S. Pat. No. 5,147,205 issued to Gross et al. Gross presented a computerized technique involving groups of three words that are flashed for a short duration on a computer screen. The rate at which the words appear on the screen is intermittently increased in jumps of approximately 10%.

U.S. Pat. No. 6,409,513 describes a system of presentation of images and text in order to improve the eye-brain connection and to improve reading speed. Includes methods for varying the reading rate of text and moving text and images in patterns to improve word recognition in peripheral vision. This invention describes a method of accelerated reading for readers who already know how to read.

U.S. Pat. No. 6,468,084 describes a system and method of teaching multiple parts of language using a microphone and tape recorder with a voice recording and voice playback component using multiple programs including word teaching, sentence teaching, and spelling training.

U.S. Pat. No. 6,056,551 shows a method of and apparatus for computer aided reading training whereby text is displayed on a video monitor screen, segmented into textual portions, each portion appearing for a duration and quantity controlled by the user.

Such patents are primarily focused on changing reading habits and improving reading skills in adult readers. Additionally, these patents assume a considerable amount of existing reading proficiency on the part of the users and are not suited to pre readers or early readers. As discussed, it is difficult to change reading habits in adult readers. It is a significant advantage over prior art that this invention presents a new method that teaches children to read in a way that develops an excellent reading style and minimizes bad habit onset.

Child instructional methods range from teacher led instruction, online educational games, multimedia presentations that that run on a computer, educational toys incorporating microprocessors and display devices, books, flashcards, and wall charts. To date, child instructional methods have failed to monitor student ability at a fine level of granularity that takes into account child comprehension of each word. Furthermore, such methods do not adapt the presentation and assessment methods on a word by word basis and therefore fail to provide smart training that is adaptive and intelligently implemented for each word.

This patent describes a new computer reading instructional technique that trains a child to read, and simultaneously trains to eliminate poor reading habits. It achieves this with a means to measure the child's comprehension associated with every word and phrase presented to the child, and then dynamically adapting its presentation and assessment techniques based on this fine grained comprehension/word repository.

### SUMMARY OF THE INVENTION

A method of teaching to read is described using methods, techniques and processes running a computer with a computer program.

### BRIEF DESCRIPTION OF THE DRAWINGS

FIG. 1 shows a computer and peripheral configuration of the preferred embodiment.

FIG. 2 shows network computers and peripheral configuration of the alternative embodiment.

FIG. 3 shows a login dialog to identify the child which is to be trained with this invention.

FIG. 4 shows a main training dialog.

FIG. 5-A shows an assessment panel that assesses word recognition using a multiple choice technique.

FIG. 5-B shows an assessment panel of FIG. 5-A with further hints provided to the child as to the correct answer in order to make the selection process easier.

FIG. 6 shows an assessment panel where the child must type the text that was trained.

FIG. 7 shows a reward panel where the child chooses a reward from a range of categories.

FIG. 8 shows a “notes” panel where a monitoring parent or teacher types progress notes about the child's activities.

FIG. 9 shows a sample flashcard report.

FIG. 10 shows a sample progress report.

FIG. 11 shows a class report that may be used by the teacher to monitor individuals within the class.

FIG. 12 shows a computer listing describing the process of operation of the reading tutor.

### DETAILED DESCRIPTION OF THE PREFERRED EMBODIMENTS

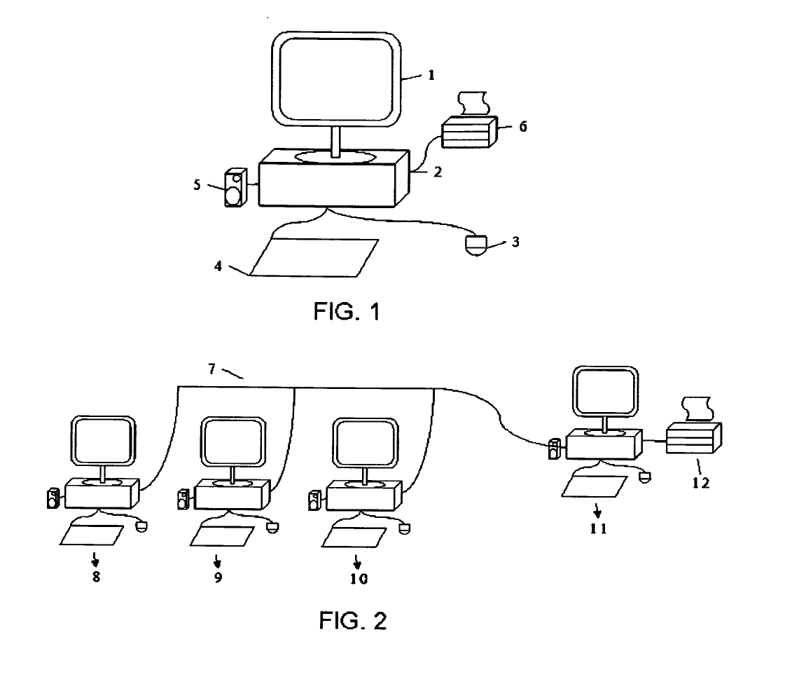

FIG. 1 shows a computer and peripheral configuration of the preferred embodiment. It comprises a computer box 2 that includes a central processing unit, random access memory, hard disk storage, and peripheral connectors. Connected to the computer box is keyboard 4, mouse 3, display screen 1, speakers 5, and a printer 6.

FIG. 2 shows the network computer and peripheral configuration of the alternative embodiment. It comprises of three client computers 8, 9, and 10 and a server computer 11. These four computers are connected together in a local network via ethernet wires 7. The server computer 11 maintains the student progress information associated with this invention in a database which is stored on its hard drive. Any children can continue a new training session by any of the using client computers 8,9 or 10 as the information associated with their progress is stored centrally on said server 11. The server 11 is connected to a printer 12 and any reports associated with this invention may be printed out using this printer by commands issued from computers 8,9, 10 or 11.

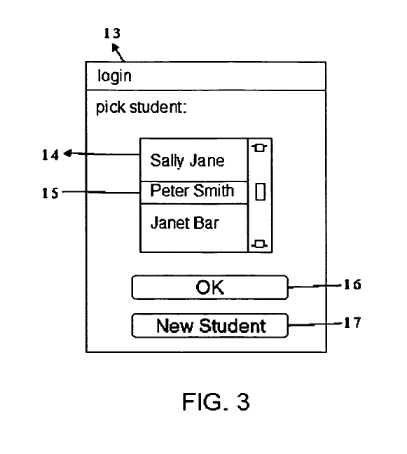

FIG. 3 shows the login dialog to identify the child which is to be trained with this invention. The dialog 13 appears on the screen 1 as the first step in the use of this invention. A list of students is displayed in a list field 14, and the child can select their name from the list. If the child's name is not on the list, then the “New Student” button 17 can be clicked and then another dialog will request the student's login name and password and this will create a new student login record. Once the child has selected their account details, then they click on the “OK” button 16. A third dialog will request their password, and once a correct password has been entered, the child is logged on and can proceed to the next stages. This login process identifies the student, c, being trained for later processing.

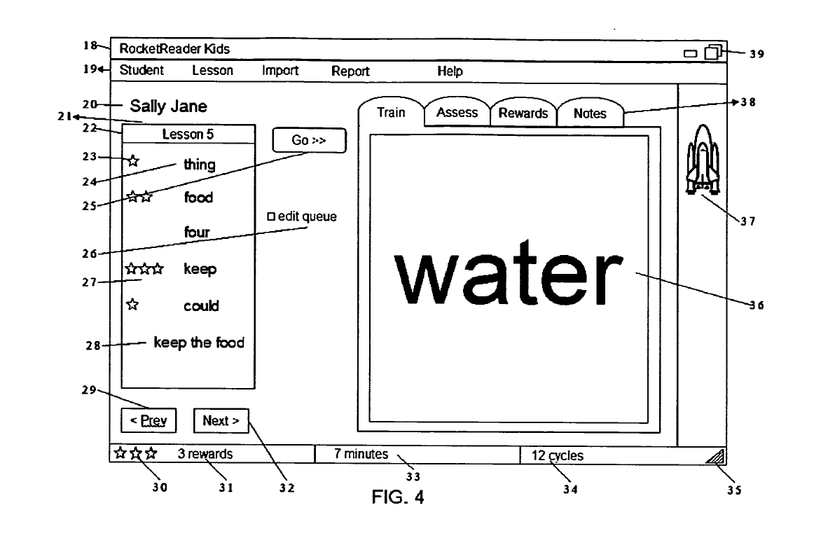

FIG. 4 shows the main training dialog. This dialog is a window displayed on the screen. A title of the window displays the name of the invention “RocketReader Kids” 18. A menu bar 19 containing menu stacks “Student”, “Lesson”, “Import”, “Report” and “Help” appears underneath the window title.

The Student menu contains options for logging in as a new student, deleting the current student, and exiting the program.

The Lesson menu. A lesson is a list of words. There are 83 lessons of increasing difficulty in the preferred embodiment where the first lesson contains very frequently occurring short words and the last lesson contains less frequently occurring longer words. The 83 lessons comprise the 1000 most frequently occurring words in the English language. The Lesson menu is a menu option for maintaining lessons and is intended for use by the parent or teacher. It contains options for
choosing a new lesson from any of the available lessons
choosing the next lessons which is slightly more difficult than the current lesson (it comprises less frequently occurring words)
choosing the previous lesson which is slightly easier than the current lesson (it comprises more frequently occurring words)
creating a new blank lesson where new custom words may be added by the parent/teacher—this new lesson can then be saved under a lesson name using the appropriate menu option.
renaming the current lesson
saving any changes made to the current lesson, for example new/changed/or deleted words within that lesson.
saving any changes made to the current lesson under a different lesson name (analogues to “Save As” in a word processor)
delete the current lesson

The Import menu is another menu option designed to assist the teacher or parent in building new lessons. It contains options for
retrieving all of the words from the contents of the computer clipboard and collating each word into the current lesson
retrieving all of the words from the contents from a user selected document (such as a MS Word Document or a PDF document) and collating each word into the current lesson
retrieving all of the words from the contents from a user selected Internet Web page by downloading the web page and then collating each word into the current lesson

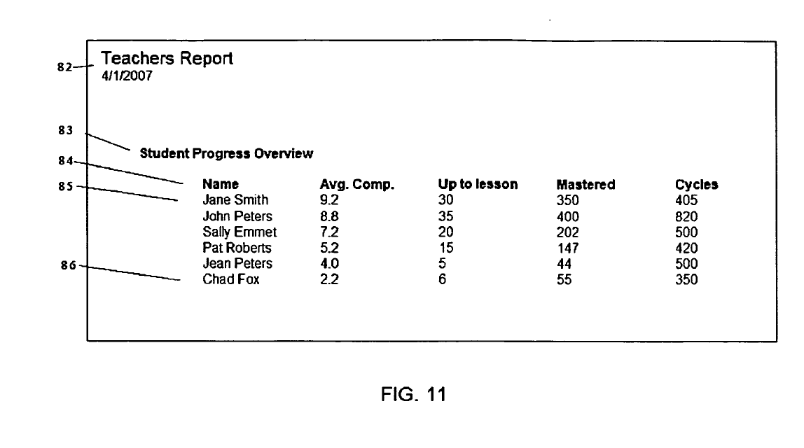

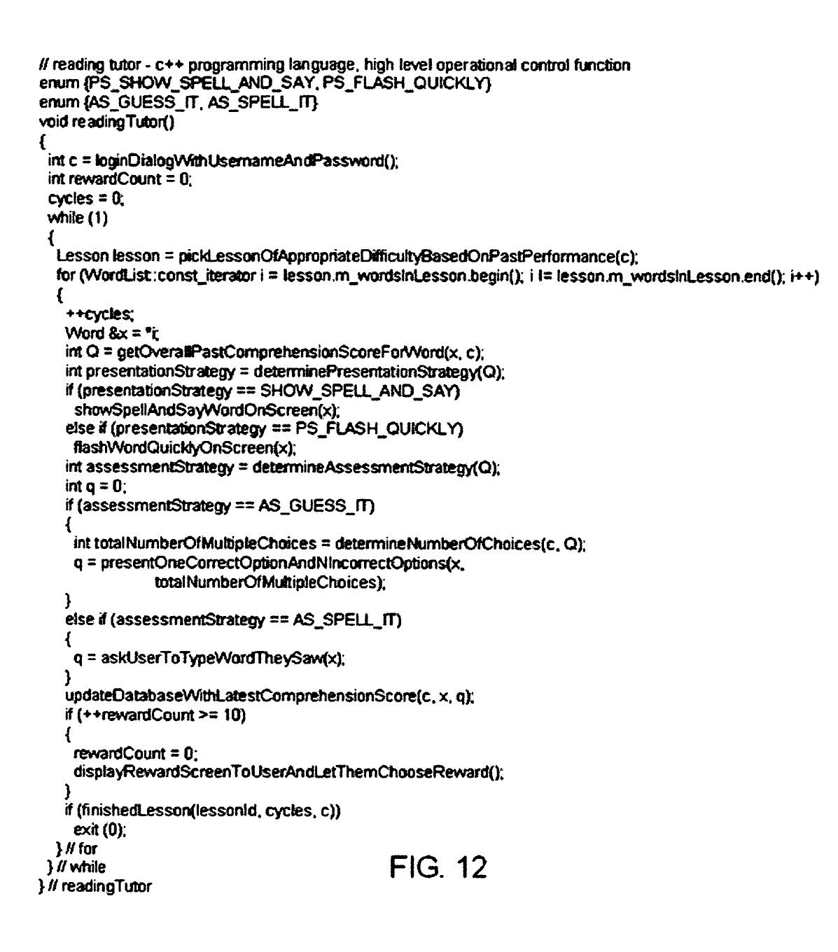

(1) The Report menu contains options for
generating a homework report for the child FIG. 11
generating a progress Report for the child FIG. 12
generating a teacher/parent overview report which includes a summary of the progress of all children who have used the program FIG. 13
The Help menu contains options for
providing instructions to the user on the operation of the program
changing the license string associated with the software
checking the Internet to see if there is a more recent version of the software available for download and subsequent installation
displaying a “About” screen that indicates the name of the software, a copyright statement, and the license code of the software

The name of the logged in child 20 is displayed near the top of the dialog. The left hand side of the dialog comprises of a text queue 21. This text queue represents the ordering of the training texts that the child will be trained once the training phase commences. The text at the top of the queue 24 is the first item of text to be trained. The text at the end of the queue 28 is the last item of text to be trained in that lesson. The order of presentation of the training texts is from top to bottom. Stars may appear next to each training text. A single star 23 indicates that the child has had some exposure but has little recognition of the associated training text (the text that appears to the right of the star). The more stars that appear, the greater the child's recognition of that training text. Three stars 27 indicates high recognition of the training text. Four stars indicates that the adjacent text has been mastered by the child. It should be noted that each item of training text corresponds to a single word in the preferred embodiment, although the parent or teacher could use the appropriate menu options and controls to create custom lessons where a text item is a short phrase containing multiple words.

The text queue 21 displays the contents of a lesson 22. The lesson is a number of text items which will be trained in turn to the child. The preferred embodiment has 83 lessons containing in total the top 1000 most frequently appearing words in the English language. The first lesson contains very commonly occurring words. Each lesson thereafter contains longer and less commonly occurring words. The first (easiest) lesson contains the words: his, one, out, she, way, of, an, see, did, get, her, him. The 82nd (second hardest) lesson contains the words: quotient, temperature, continent, condition, substance, experience, continue, necessary, particular, especially, discuss, practice.

The child can choose a lesson by advancing one set at a time using buttons “Prev” 29 or “Next” 30. Clicking on the “Prev” button will load the prior (slightly easier) lesson and display the contents in the text queue. If the text queue is displaying the easiest lesson, a click on this “Prev” button will result in no action. Note, if the child has not mastered the words in the current lesson, clicking on the “Next” button will not permit them to advance. If they click on the “Next” button, and they have not mastered the current lesson (according to saved comprehension scores for the texts within that lesson), then a message is displayed informing that they cannot proceed until they master the current lesson. This message dialog will also contain a field allowing the teacher/parent to enter the teacher/parent password to override this so as to force the next level to be retrieved. If the text queue is displaying the hardest lesson, a click on the ‘Next’ button will result in no action.

A teacher can create and customize texts set by clicking on a “edit queue” toggle 26. Once they click on this toggle a dialog will appear asking them to enter a “teachers” password. Once a correct password has been entered by the teacher, additional editing buttons appear on the dialog directly below the “edit queue” toggle, and the “edit queue” toggle is checked. These newly displayed buttons are labeled “add”, “delete”, “top”, and “bottom”. The teacher may then use these buttons to alter the contents of the text queue and change the ordering of items therein. Their changes may be saved using a “Save” menu button contained in the “Lesson” menu stack in the menu bar 19.

Once the child is ready to commence training he or she will click on the prominent “Go” button 25. This button will result in the top most item in the text queue being removed 23, 24 in preparation for a training cycle using that removed text. The remaining text items all move up one position in the word queue to take up the gap created by the removal.

A group of tabbed panels 38 appears on the right hand side of the dialog. This tabbed panel group contains individual panels “Train”, “Assess”, “Rewards” and “Notes”. When the child has clicked on the “Go” button the “Train” panel becomes active (is displayed) and the training text 36 is presented in one of a number of different ways, as will be explained, depending past recorded information in the current child's session or in prior sessions with that child.

A past comprehension score Q(c,x) is calculated for the training text x. The calculation method will be explained presently. The calculation method returns a whole number value from 1 through to 10, where a value of 1 corresponds to unseen text or very poor comprehension and a value of 10 corresponds to very high understanding.

If the Q(c,x) value is 1, 2, or 3. Then inside the “Train” panel the training text x is displayed in a large font 36. Additionally a recorded voice will speak in the following sequence through the computer speakers 5
spelling of the text letter by letter by saying aloud the sound of each letter,
saying the word,
spelling the text letter by letter using the standard alphabet, and then
repeating the word, and then
saying the word by blending word sounds together, for example the word “brick” may be spoken in two parts, the first part the sound associated with “br” and the second part, the sound associated with “ick”.

For example, with the specific training text instance 36 of “water” the computer speakers will output “w-a-t-e-r, water, W-A-T-E-R, water”. Furthermore, the child can move the computer cursor around over the letters in the word water and as they move the mouse over any letter, that letter is said aloud through the speakers and is visually highlighted by making the visual strokes on the font of that spoken letter appear darker than the other letters in the word being displayed. So, if the child moves the mouse over the first letter in this example, the first letter would be displayed darker than the other letters and the speakers would say out loud “W”. Once the child clicks with the mouse button in any area within the “train” panel action proceeds to an assessment” phase.

If the Q(c,x) value is greater than 4. Then the Train panel is displayed as a blank area for 1 second, then the training text is displayed for a very short duration of 30 ms in a large font within the train panel, then a mainly blank screen is displayed for 0.5 seconds. This provides a rapid presentation of the training text and provides an opportunity for the child to read the text rapidly. Results from eye-tracking studies have shown that the time required to move the eyes from one fixation position on the screen (a saccade) to another is 20 to 30 milliseconds. The time required for an eye fixation is 250 ms to 500 ms. It should be noted that studies have shown that reading is only carried out during a fixation and the eyes are effectively blind when the eyes are moving in a saccade. It is clear that the display time of the training text is short enough that only one part-fixation can be physically undertaken by the child to read the text. In fact, once the text has disappeared the child must read the text from his or her persistent vision for the remaining part of their fixation. This is why a blanked Train panel is displayed after the text is removed for a further duration of 500 ms. Once the text has been flashed and the blank panel has been displayed, the “Assess” panel is activated and displayed.

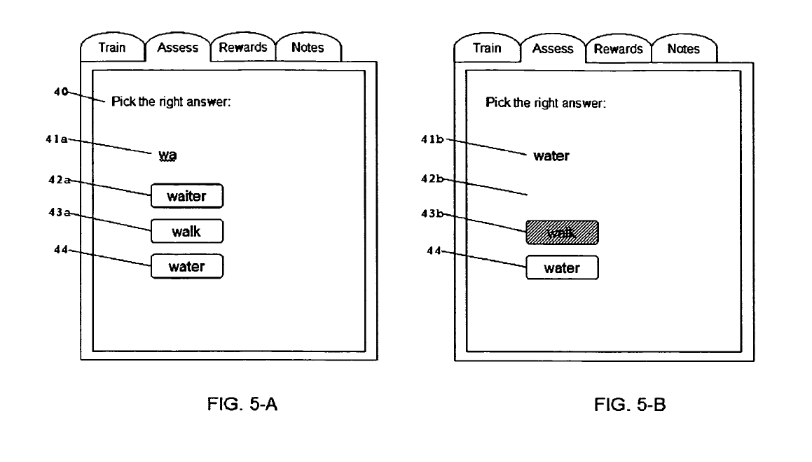

Assessment of comprehension of the trained text is done in one of two ways depending on the value of Q(c, x). FIG. 5-A and 5-B shows an assessment panel that assesses word recognition using a multiple choice technique. There are different methods of assessment depending on the value of Q(c, x). FIG. 5-A shows the “multiple choice” method that is used when the Q(c,x) values of the training text x are 1,2, or 3. This method displays one correct answer 44 and up to 3 incorrect answers 42a, 43. Each possible answer appears as a label on a button. The correct answer is positioned randomly in the button order from top to bottom. The incorrect answers are chosen according to the following method.

Method to choose n incorrect options from a dictionary d, where the incorrect options are similar to the given text x.
1. A dictionary d containing English words is used as a data source in later steps.
2. If the correct text x has more than 4 characters, then select 50 different words (if this many are available) from the dictionary where the first two letters of the dictionary word are the same as the first two letters of the text x.
3. If the correct text x has 4 or less characters, then select up 50 different candidate words from the dictionary d where the first letter of the dictionary word is the same as the first letter of the text x.
4. With these selected candidate word list, remove the text x from the list if present.
5. Measure the similarity of each word w in the candidate words set to the text x using a similarity measure s(w, x)
6. Return n candidate words that have the highest similarity scores.

The following similarity measure is described. This measure is used in the process of selecting incorrect options in the multiple choice questions. Calculate the similarly measure s(a, b) from two items of text a and b
1. if the number of characters in text a and b is identical score one point
2. score one point for each character that appears anywhere in a that also occurs anywhere in b without double counting
3. score one point for each character that has the same value and same position from the start, in text strings a and b.
4. return the number of points totaled.

The value of n (the number of incorrect multiple choice options) from the above said method “Method to choose n incorrect options from a dictionary d” is chosen according to the following values Q(c, x).
1. If Q(c, x) is 0 or 1 then n is 1
2. If Q(c, x) is 2 then n is 2
3. If Q(c, x) is 3 then n is 3
4. If Q(c, x) is 4 then n is 4

In this way, the better the past measured comprehension for the word x, then the more multiple choice options are presented making the assessment process more challenging and accurate.

Using this similarity measure, as an illustrative example, the two string “drain” and “drank” would have a score 1 (same length) plus 4 (they both have in common letters d, r, a and n) plus 3 (they both start with “dra”) to give a total similarity measure of 8.

The incorrect answers, chosen using this method are displayed randomly on the button labels. FIG. 5-A shows the correct answer 44 displayed with two incorrect answers 42a and 43.

At this point hints are provided to the child to trigger the child to select the correct answer. If a period of three seconds elapses and no button click is recorded, the first letter of the correct answer is displayed in area 41a. If a further period of three seconds elapses and no button click is recorded, the first two letters (if present) of the correct answer is displayed in area 41a. This process proceeds until all letters of the correct answer are displayed in 41b. Then, if a further period of three seconds elapses and no button click is recorded then a randomly selected incorrect option is changed so that it displays a red colored button face. Then, after a half a second, the red colored button is hidden from the panel as in 42b. Then, if there was more than one incorrect option displayed, and if a further period of three seconds elapses and no button click is observed then another randomly selected incorrect (displayed) option is changed so that it displays a red colored button face as in 43 and again is removed after a further half second. This process is repeated after further periods of inactivity until only the correct button remains. If at this point the child fails to click on the correct button after a further delay of three sections, then the correct button will flash between its normal display color and a green face display color changing between these states every 0.5 seconds for a total duration of two sections. If no click is recorded during this flashing stage the program will at that point have exhausted all hinting options and will continue to the next step as if the child clicked on the correct button.

During this assessment if the child clicks on an incorrect option, the button face will be changed to a red color, and after a half a second that incorrect button will be removed from the panel. If the child clicks on the correct option, the button face will change to green, and the word is said aloud through the computer speakers, and the program continues on.

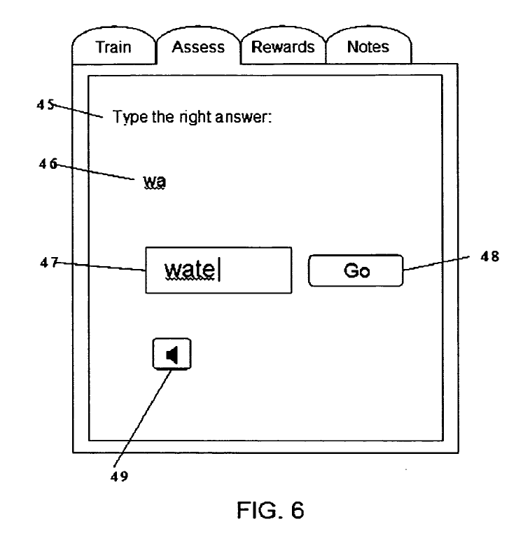

The second assessment method is used for Q(c,x) values in the range 5 to 10. This assessment method is illustrated in FIG. 6 and requires the child type with the keyboard the training text into an edit field 47 in the assessment panel. At the top of the screen some text 45 instructs the child to “Type the right answer”. A hint area 46 is initially displayed as blank. If the child types a wrong character in the sequence of typing the training text then the computer will generate a short “buzzer” sound in the speakers to indicate a wrong key was pressed, and the hint area in 46 is display the first n characters of the correct answer where n is the number of characters that appear in the typing field 47. So, if the correct answer is “water” and the child types “wap”, then the text “wat” will be displayed in the hint area 46. The hint area is also used to assist in the case of inaction. If the child has typed n characters, and fails to type any further characters for a period of five seconds, then the first n+1 characters of the answer will be displayed in the hint area 46. For example, if the correct answer is “water” and the child types “wa” and pauses for five seconds, then the hint area will display “wat”. The child can click on the speaker button 49 at any time to hear the training text through the computer speakers to assist in the process of typing the correct answer. Once the child clicks on the “Go” button the assessment score Q(c,x) is calculated according to the following formula

Calculate a q1 measure q1 (a, x) from two items of text a (what the child typed in) and x (the Correct Text)
1. if the number of characters in text a and x is identical score one point
2. score one point for each character that appears anywhere in x that also occurs anywhere in a without double counting
3. score one point for each character that has the same value and same position from the start, in text strings a and x.
4. deduct one point for each hint that was supplied due to inaction on the part of the child
5. deduct one point for each hint that was supplied to the typing of an incorrect character
6. with the total number of points p, and the number of characters in the text c, calculate the quantity q1=10p/(2c+1)
7. if q1 is less than 1, set q1 to 1
8. return q1, (q1 is now normalizes score in the range 1 to 10)

Once the child has typed their answer they click on the “Go” button 48 to continue to the next phase.

When the child chooses or spells correctly the correct answer during the assessment phase the computer plays a spoken recording of the correct text through the computer speakers to positively reinforce the selection.

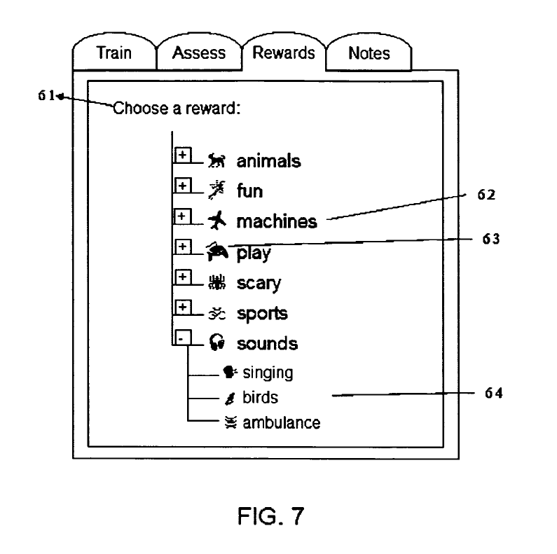

After the assessment phase is complete, regardless of the child's comprehension of the assessment text, the picture of a rocket 37 is then redrawn so that it appears closer to the top of the screen. The Rocket is moved up by one tenth of the vertical extent of the panel in FIG. 4. If the Rocket reaches the top of the screen, the rewards phase and corresponding display (FIG. 7) is triggered, as is described next. Once the reward phase is complete the Rocket is then redrawn in the same horizontal position but at the bottom of the screen. If the rocket has not reached the top of the screen another cycle of word presentation and assessment continues.

The reward phase starts by displaying the contents of the rewards panel in FIG. 7. At the top of the panel a label 61 instructs the child to “Choose a reward”. In this panel top level reward categories are displayed in a tree display field and each category includes a small image 63, and a title 62.

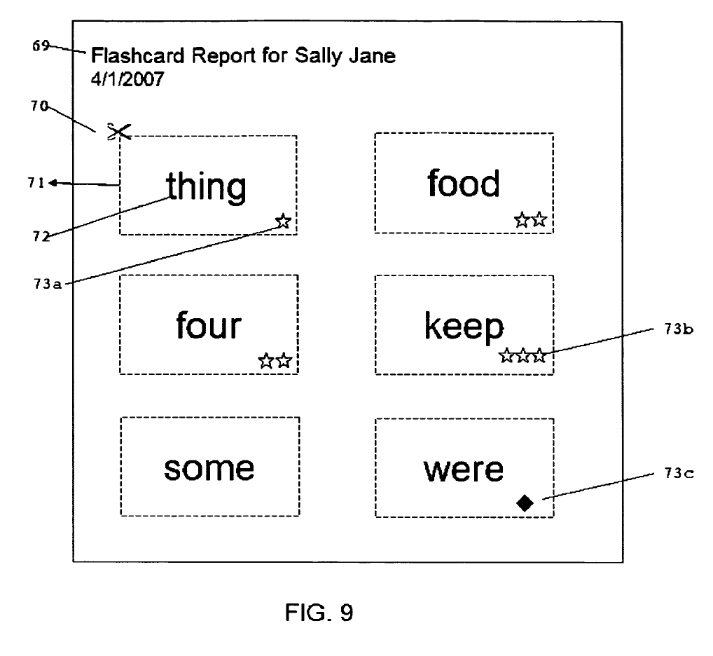

To the left of each category an expand “+” symbol or collapse “−” symbol is displayed. These behave and operate like the standard expand and collapse buttons used in tree display fields. If the child clicks on the “+” symbol or on the category icon or category title, the contents of that category expands and is displayed. On FIG. 9, the “Sounds” category is displayed in its expanded state. To collapse back an expanded category and its subcategories, the child must click on the “−” symbol or on the category icon or category title again. In the instance described in FIG. 9 the “sounds” categories has reward items “singing”, “birds”, and “ambulance” if the child clicks on any of these subcategories the corresponding sound will be played through the computer speakers. The other categories contain photographic pictures that are displayed in a popup window to the child when selected. For instance, the “scary” category contains pictures of a spider, tiger, and a lion. Once the child has selected a reward item, and it has been presented to the user, for a duration of 10 seconds, the reward phase is complete. A recorded voice prompt tells the child that the lesson is continuing and a new training cycle commences with the next text item on the word queue. The child may only choose one reward item in the reward phase. Immediately after the completion of the reward phase, the said rocket 37 in FIG. 4 is redisplayed at the bottom of the window just above 35.

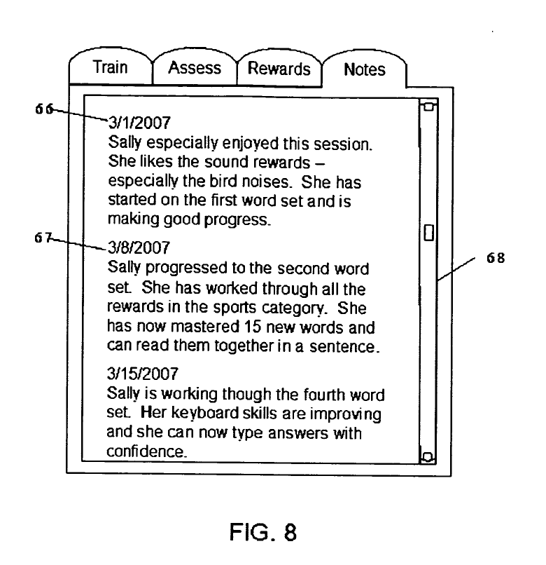

At any time in the reading tutor the parent or teacher may click in the “Notes” in FIG. 4 (part 38). When this click is registered the reading tutor program will require that the parent or teacher enter the correct parent/teacher password before continuing. When a correct password is entered, the contents of the Notes panel is displayed and the teacher or parent may add or change notes in that edit area FIG. 8. The reading tutor will automatically save the changes made in the notes. When a progress report is printed, these notes will appear on the report.

At any time in the reading tutor a flash card report FIG. 9 may be generated for the child using the “Homework” menu option in the “Report” menu stack (FIG. 4, part 19). When this report is invoked, a report will be generated and displayed in a web browser. This report may then be printed or sent via email using standard web browser printing, or email functions. This report displays the date generated and the child's name whom which the report relates to 69. This flashcard report displays words that have been trained to the child with a number of stars (zero to four) appearing next to each word. The number of stars corresponds to the child's aggregate comprehension Q(c, x) of that word x. In the sample report, the word “thing” was not very well read by the child and has one star 73a. The word “keep” was recognized much better by the child and has three stars 73b. The number of stars communicates to the parent how well the child knows each word, so they can focus on practicing those words with fewer stars on a more frequent basis. The report also displays the words that are due to be displayed in the next sequential lesson (which is slightly more difficult), and these words are identified using the diamond symbol 73c. Only one such word is included in this sample report however all of the words in the next lesson would be displayed (typically 12 words per lesson) in this report with an associated diamond symbol. This allows the child with their parents to pre-learn words in an offline fashion in preparation for the next reading tutor lesson.

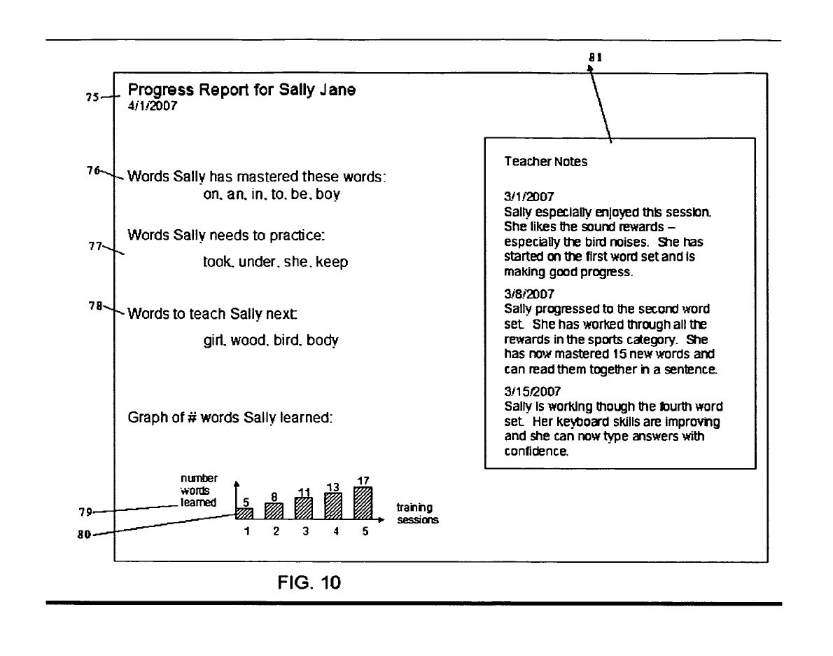

At any time in the reading tutor a progress report FIG. 10 may be generated for the child using the “Progress” menu option in the “Report” menu stack (FIG. 4, part 19). When this report is invoked, a report will be generated and displayed in a web browser. This report may then be printed or sent via email using standard web browser printing, or email functions. This report displays the date generated and the child's name whom which the report relates to 75. The first section of the report shows a list of words that the child has mastered 76 based on high comprehension values Q(c, x) (values greater or equal to 7) for each of the words. The next section 77 displays a list of words that the child needs to practice and these words are based on lower comprehension values Q(c, x) (values less than 7). The next report section 78 displays a list of words that should be taught next to the child, and these words will be appearing in the next reading tutor lesson. The words in this section are the same as the words marked with a diamond symbol in the “Flashcard report”. The next section is a bar chart showing the cumulative number of words mastered in each session of use of the reading tutor. The y axis 79 is the cumulative number of words mastered. A word x is considered master if it has an associated comprehension score Q(c, x) of 7 or greater. The x axis 80 displays the number of training sessions, where a value of 1 corresponds to the first training session, and a value of 5 corresponds to the 5th training session which may have occurred a number of days from the first training session. The purpose of this graph is to show the child and the child's parents that the child is learning and mastering new words with the reading tutor and to provide motivation and feedback. On the right hand side of this report, the parent or teacher's notes 81 are displayed as may have been created from time to time by the parent or teacher using the notes panel in FIG. 4, part 38. The purpose of this section is to communicate and document any session notes relating to the child's progress that teacher or reading specialist may have entered back to the parent.

At any time in the reading tutor a teacher/parent overview report FIG. 11 may be generated for all of the children who have used the reading tutor (and have not been deleted) using the “Teacher/Parent overview” menu option in the “Report” menu stack (FIG. 4, part 19). Once this report menu option is selected, the parent or teacher must enter the parent/teacher password. If they enter the correct password, the following report will be generated. Once generated the results are displayed in a web browser. This report may then be printed or sent via email using standard web browser printing, or email functions. This report displays the date generated 82. The section title 83 is the “Student Progress Overview”. This section contains five column headings 84. The “name” column contains the student login name. The “Avg. Comp.” column contains the average comprehension values of all words attempted by the child, which is an average of the Q(x, c) values for all values of x which have been trained to the child c by the reading tutor. The “Up to lesson” column indicates which sequential lesson number the child is up to, where lesson 1 corresponds to the easiest lesson and lesson 83 corresponds to the hardest lesson in the reading tutor. The “Mastered” column indicates the number of words mastered by the child, and these words have a comprehension value Q(c, x) of 7 or greater. The “Training Cycles” column displays how many times any words have been trained with the child, including repeat presentations of the same word, and this corresponds to the number of training cycles. All of the children who have used the reading tutor are then listed in this section with a row describing the progress of each child. The rows are order by decreasing numerical value of average comprehension. The child with the highest average comprehension is listed first 85 (in this example Jane Smith) and the child with the lowest average comprehension listed last 86 (in this case Chad Fox). This report allows the teacher to monitor student progress and achievement and may be suitable for allocating further time and resources to children with lower achievement scores.

FIG. 12 shows a computer listing describing the operation and control of the main training routine in this invention. The main training function readingTutoris invoked when the reading tutor program is started on the computer. The function loginDialogWithUsernameAndPassword provides logging in functionality and returns a student identifier c which uniquely identifies the child. Then a master while loop starts. Within this loop a lesson is chosen (function pickLessonOfAppropriateDifflcultyBasedOnPastPerformance), and then the words in that lesson are successively trained with the child. The lesson object (lesson) is described by class Lesson. Within the lesson object there is an iterator object (m_wordsinLesson) which is used within the for loop to iterate through each word within the lesson. Within that for loop, the past comprehension aggregate Q(x, c) (and is stored in variable Q) is calculated for the current word x (described by the value of the iterator *i) and the current child c. Next, the presentation strategy is determined by function determinePresentationStrategy. The word x will then be presented to the child with either function showSpellAndSayWordOnScreen, or flashWordQuicklyOnScreen. The assessment strategy is then determined with function determineAssessmentStrategy. The appropriate assessment strategy is then presented to the user to determine their comprehension of the word, and that comprehension quantity is stored in variable q. Then the function updateDatabaseWithLatestComprehensionScore saves the value of q, along with associated values of x and c in the database so that an updated values of Q may be calculated on subsequent trainings of that word x to that child c. Then, if ten words have been trained to the child, the child will enjoy a reward which is invoked and displayed by function displayRewardScreenToUserAndLetThemChooseReward. If the lesson is complete (determined by function finishedLesson), then the program will exit, else it will continue in the training loop. On continuation, the next word in the lesson is selected.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

### CONCLUSIONS, RAMIFICATIONS, AND SCOPE

The advantage of this invention is an improved technique to teach a child to read.

This invention could apply to adults who have poor reading skills.

This invention could be used in conjunction with a Learning Management System (LMS), where the reading tutor exports results and transfers them to the LMS using a standard LMS protocol (eg. SCORM) or by using the protocol specific to the LMS. The LMS can then store the results and combine other results generated by other learning programs such as a mathematic training program and then provide reports (as an example) for the student, the parent, the teacher and the school administrator. LMSs are becoming more common in educational sector especially in schools and college. This invention is a natural fit to share data with such a system.

This invention refers to a teacher or parent who plays the role of monitoring student progress and having access to controls not available to the child. This person, described herein as teacher or parent, could be a reading specialist, learning disorder specialist, tutor, or other specialist who is working with the child or children using the reading tutor.

This invention could apply to people who have mental conditions that impair their ability to read. Reading disorders, such as Dyslexia and Meares-Irlen (Scotopic Sensitivity) Syndrome, affect a significant number of people. Dyslexia is the most common cause of reading difficulty—it is estimated that one in 10 children is dyslexic.

Being affected by a reading disorder can be a daunting and frustrating experience for a child and, if not properly addressed, might lead to low self-esteem and underachievement in adult life. At the same time, children with dyslexia are often characterized by above average intelligence, and can excel if given proper attention and assistance. History is full of examples of great people who have overcome dyslexia to achieve enormous success—George Washington and Albert Einstein being probably the most famous. Research has consistently shown that people with reading disorders can benefit from specifically designed reading tuition and improve their reading skills and ability to process information at any age. However, the earlier the problem is diagnosed and addressed, the better chances of successfully overcoming it a person has. According to the International Dyslexia Association, 74% of the children who are poor readers in 3rd grade remain poor readers in the 9th grade. This means that they cannot read well as adults.

Given the preparation of suitable content in a different language, other than English, this invention could apply to training to read in languages other than English. Hence, this invention could apply to people who are trying to learn and read a new language.

What is claimed is:

1. A method for teaching reading using a computer, comprising:
providing a display device;
providing a character input means which a child can use to enter a series of characters;
providing a pointer means in which said child can point to a location on the display device;
providing a pointer selection means in which said child can make a selection using said pointer on said display device;
providing a central processing unit linked to computer memory and computer storage that is connected to said display device, character input device, pointer means, and pointer selection means, running a reading instruction computer program, and operations and instructions within that computer program to provide;
means for identifying the child (referred herein by c) that is to be trained using said devices means to select a lesson comprising of a set of words or phrases which are to constitute a training session for that child;
means to choose which word or phrase is to be used in the next training cycle, this word or phrase is referred to as the Training Text, or x;
means to determine the past reading performance of the child of the specific training text x using recorded information from said computer storage from the current and past training sessions with that child for text x, this aggregated measure of performance is referred hereafter as Q(c,x);
means of training the word or phrase to x the child where the choice of training technique is determined by Q(c,x);
means to measure the child's comprehension of the training text x, where the choice of comprehension measurement method is determined by Q(c,x), where the new comprehension value for the newly presented word x is referred to as quantity q;
in the case where the child cannot read the text x, means to present hints to trigger recall in the child of the meaning of the training text;
means to store the new comprehension q quantity that permits later retrieval by the reading tutor program with respect to the training text x and the child c who was trained in order to generate an updated value of Q(c, x), for the next training cycle of that text x by child c, referred to as Q′(c, x);
means to occasionally reward the user for progress and perseverance;
means to determine which word or phrase is to be trained next; and
means to determine when the lesson is complete and to finish, or else, means to repeat the training steps above.

2. A method of [claim 1] where the said reading tutor computer program operates in a client/server configuration, whereby the main database (and other server based operations) run on one or more central server computer(s) connected to the Internet, and where the child being trained uses a client computer that is connected to a server via an appropriate Internet communication protocol, and where the child's client computer provides the child means for interacting with the reading tutor by running a thin client such as a java application, a web browser, a Net application, or other thin client technology.

3. A method of [claim 1] which further provides:
auditory feedback using sound-producing computer hardware to the student to enhance the instructional effectiveness, and
reports that provide homework for offline revision and that also summarizes the progress of the student and that these reports may be sent by email or printed on an attached computer printer.

4. A method according to [claim 1] where for presentation text x, in the case the value Q(c,x) falls within a constant range, the step “means of presenting a word or phrase to the child using a computer where the technique of presentation is determined by Q(c,x);”, further comprises the steps:
a concentration phase; preparing for the rapid display of the text by displaying a mainly blank screen region for a duration of between 0.4 to 3 seconds;
a priming phase; preparing the child for the imminent display of the text by displaying a mainly blank screen region and changing the visual presentation of the region using images such as a window frame or set of cross hairs or other visual indication for a duration of 0.25 to 2 seconds;
a flash phase; presenting the text rapidly on the screen within the screen region for a duration of less than 0.5 second, and I
a fixation phase; displaying a mainly blank screen to facilitate the eyes to read the flashed words from their persistent vision for a duration of between 0.3 to 2 seconds.

5. A method according to [claim 1], in the case of the value Q(c,x) falling within a constant range where the step “means of presenting a word or phrase to the child using a computer where the technique of presentation is determined by Q(c,x);” further comprises the steps of:
setting the duration of the text or phrase to be displayed based on the value of Q(c,x), where a longer text display duration corresponds to a lower Q(c,x) value, and vice versa, where a shorter text display duration is controlled by higher values of Q(c,x);
displaying the text on the screen for said duration; and
removing the displayed text once the display duration has expired.

6. A method according to [claim 1] where he step “means to determine the past reading performance of the child of the specific training text x using recorded information from said computer storage from the current and past training sessions with that child for text x, this aggregated measure of performance is referred hereafter as Q(c,x);”, further comprises of:
for the child being trained (referred to as c), and the training text selected (referred to as x), calculating the average past comprehension score values, named quantity A(c, x), of that specific training text x by calculating the statistical mean of individual past recorded assessment scores for that child of that text x;
calculating the number of times, N(c, x), that text x has been previously presented to the child; and
then calculating a prior comprehension indicator quantity Q(c, x) which is a relation R of quantities A and N, or symbolically, Q=R(A, N).

7. A method according to [claim 1] where the step “means to determine the past reading performance of the child of the specific training text x using recorded information from said computer storage from the current and past training sessions with that child for text x, this aggregated measure of performance is referred hereafter as Q(c,x);”, further comprises of:
for the child being trained (referred to as c, and the training text selected x, calculating a fading memory comprehension score, named quantity F, of that specific training text by calculating:
for the child being trained, c, and the training text, x, calculating an overall “fading memory” measure of the average past comprehension values, named quantity F(c, x), by calculating a time-weighted measure of comprehension scores for that child of each individual assessment score of that training text; where a recent comprehension score has greater or equal weight in its contribution to F(c, x) than a less recent comprehension score. This models the situation where more recent comprehension scores of the text x have more weight in the quantity F than less recent comprehension scores for x, and strives to provide a better assessment for a child where the most recent comprehension scores for a item of text x is more relevant to their current state of understanding of the text x than his or her earlier comprehension scores of that text x;
calculating the number of times, N(c, x), that the training text to be displayed x has been previously displayed to the child; and
calculating a prior comprehension indicator Q(c, x) which is a relation R of quantities F(c, x) and N(c, x) or symbolically, Q=R(F, N).

8. A method according [claim 1] w
international spelling variations of any displayed text is determined and resolved automatically by examining the country designation in the settings of the computer or computer's network settings that is running of the program, and is best matched against the available regional text spelling variations in the database of spelling alternatives in the computer reading tutor, and the best matching spelling is used; and
the vocal international accent of any voice that is used is determined automatically by examining the country designation in the settings of the computer or computer's network settings that is running of the program, and is best matched against the available accents in the computer tutor, and the best matching accent is used.

9. A method according to [claim 1] where the step “in the case where the child cannot read the text x, means to present hints to trigger recall in the child of the meaning of the training text;”, further comprises the steps:
reviewing past requests for hints by the child;
using the value Q(c, x) to estimate the expected comprehension of the text; and
then determining a hint presentation method so as to provide a minimal stimulus to trigger comprehension of the text.

10. A method according to [claim 1] here the step “means of training the word or phrase to x the child where the choice of training technique is determined by Q(c,x);”, further comprises:
displaying the training text on the screen;
when the pointing device is moved over a letter within the displayed text on the screen a recorded voice speaks that letter aloud through the computer sound device;
a recorded voice spells the text aloud letter by letter and as this proceeds as each corresponding letter is spoken the spoken letter within the text is highlighted visually on the screen;
a recorded voice spells the text aloud letter by letter by saying aloud the sound of each letter and as this proceeds as each corresponding letter sound is spoken the spoken letter within the text is highlighted visually on the screen;
a recorded voice says the word in parts by blending letter sounds together, for example the word “brick” may be spoken in two parts, the first part the sound associated with “br” and the second part, the sound associated with “ick”, and as each part is said aloud the blended letters corresponding to that spoken part are visually highlighted on the screen;
a recorded voice speaks the entire word or phrase displayed through the computer sound device;
an image or multimedia presentation is presented to the child to provide a visual indication as to the meaning of the displayed text x; and
a sound recording or multimedia presentation is presented to the child to provide a example of the word used in a sentence.

11. A method according to [claim 1], in the case where Q(c, x) falls within a constant range, the step “means to measure the child's comprehension of the training text x, where the choice of comprehension measurement method is determined by Q(c,x), where the new comprehension value for the newly presented word x is referred to as quantity q.”, further comprises:
hiding the presented training text from the child;
communicating to the child that they must remember and spell what was displayed on the screen;
using a human-computer device such as a keyboard, and then recording the spelling attempted by the child for the phrase that he or she saw;
allowing the child to type in the word that they saw, but providing positive and negative feedback during the typing phase, where positive feedback consists of saying a recording of the correctly typed letter aloud directly after the letter was typed, and negative feedback consists of using sounds and or graphic displays to indicate an incorrect letter was pressed directly after the incorrect letter was pressed;
limiting the entry of the typed text such that if an incorrect letter is pressed, then the cursor is locked in that position and the child must try different alternative letters in that position until the correct letter is entered and after the correct character is entered, advancing to the next character in the text, in a manner that permits at most one incorrect letter to appear at the end of a string of correct letters; and
determining and recording the comprehension for the training text according to degree of match between what was presented to the child and what was typed in by the child, and the number of typing mistakes that were made.

12. A method according to [claim 1], where at the specific request of a parent or teacher a human assisted comprehension method is used to determine the value of q for each word x trained, where this comprehension method uses the judgment of a third party (the monitoring teacher parent) or the child (self assessment), where this comprehension method comprises;
a human assisted comprehension assessment method where a series of pictures is displayed where the visual theme of the pictures range from “poor comprehension” through to “excellent comprehension” and then recording which picture was selected by the assessing person via some human/computer interaction method such as a mouse click, as a means to assess how well the child understood the last training text presented;
a human assisted comprehension assessment method comprising of presenting a series of grades, for example A, B, C, D, E, and F, and then recording which grade was chosen by the assessing person as a measure of how well the child understood the training text; and
a human assisted comprehension assessment method comprising presenting a series of numbers, for example 1, 2, 3, . . . , 10, where a low number corresponds to a lower understanding of the training text than a higher number, and then recording which number was chosen by the assessing person as an indication of how well the child believed they understood the training text.

13. A method according to [claim 1], the steps “means to measure the child's comprehension of the training text x, where the choice of comprehension measurement method is determined by Q(c,x), where the new comprehension value for the newly presented word x is referred to as quantity q.” further comprises:
an automated assessment method comprising of presenting a series of options to the child where each option is displayed in random order and consists of a possible matches of the text x that was recently trained, where there is only one correct exact match x and one or more incorrect near matches, and then after the correct selection is selected by the child, calculating the comprehension of that text x by a method that makes use of the sequence and timing of selections made by the child.

14. A method according to [claim 1], wherein the steps “means to occasionally reward the user for progress and perseverance”, further comprises:
displaying a visual indication during the lesson of how close the child is to receiving a reward, and when the child completes further training cycles, the visual indication shows the reward is drawing closer until such a time that sufficient progress has been made and the visual indication then shows the reward is ready to be enjoyed, and when due as said, the presentation of the reward comprises the steps;
displaying a number of reward categories;
allowing the child to choose a category and a reward within that category;
presenting the selected reward to the child using an appropriate static picture display, animation, sound, short game, puzzle or short interactive game corresponding on the specific reward selected by the child;
limiting the reward so that only one reward can be enjoyed (when due) and then further training must be done before the next reward is due; and
limiting the duration in which the reward is displayed to the child, and when that duration has elapsed, continuing on with further training.

15. A method according to [claim 1], wherein the steps “means to occasionally reward the user for progress and perseverance”, where the said reward is selected automatically by the computer program such that the nature of the reward thematically matches the theme or context of the training words recently presented.

16. A method according to claim [claim 13] where the reward categories available for the child to choose from are “animals”, “fun”, “machines”, “play”, “scary”, “sports”, “rocket”, “interactive” and “sounds”.

17. A method according to [claim 1] where at any time during the training session a monitoring teacher or parent can choose an interface option that displays child progress notes entered by a parent or teacher relating to the child being trained and where they can add/change progress notes at that time which will be automatically stored and made available for later editing, review or reporting.

18. A method according to [claim 1] where the steps “a method to choose a set of words or phrases which are to constitute the training session for the child”, comprising:
having a predefined series of lessons, where each lesson contains a set of words;
each predefined lesson is tagged with a lesson number, starting from the easiest lesson, lesson 1, where a lower numbered lesson corresponds to sets of words that occur more frequently in the English language and comprise words of smaller size;
for a child that has not used the reading tutor before, starting at lesson 1 by default;
for a child that that has used the reading tutor before, choosing the lesson L with the largest lesson number that satisfies the following; each word in the lesson has been trained before by the child, and the child has reached a minimum level of comprehension Q+ for each word in the lesson, and then if that lesson L is not the last lesson, choosing lesson L+1 as the next lesson for training by the child;
allowing the child to use the graphical user interface to manually change the lesson to any easier lesson;
not permitting the child to choose lessons that are harder than the most advanced lesson that they have mastered, where a lesson is considered mastered where the Q(c, x) scores for that child c, for each of the words x in that lesson are sufficiently high; and
providing a method where the parent or teacher can override the restrictions on child's lesson availability and by exercising this override allowing the child to choose any lesson.

19. A method according to [claim 1] where which includes an additional process initiated by a menu option or button in the reading tutor where manually constructed lessons can be created by the parent, teacher or child, and those custom lessons can be saved by the reading tutor software, and then during later operation of the reading tutor, these saved lessons may be later selected for use by the parent, teacher or child in the step of [claim 1], “means to select a lesson comprising of a set of words or phrases which are to constitute a training session for that child”, where the new process of custom lesson construction comprises;
a method for a teacher or parent to create, modify or add to a training set of words by entering in words or phrases through a graphical user interface;
a method where the teacher or parent nominates that they wish to use the contents of the computer's clipboard memory as a text source, and the text stored in the computer's clipboard memory is used and the words and phases are extracted from the clipboard text to form a new training list or add to an existing training list;
a method where the teacher or parent nominates that they wish to use the contents of a specific web page as a text source, and the text on that web page is then downloaded from the applicable web site and then words and phases are extracted from that page to form a new training list or add to an existing training list;
a method where the teacher or parent chooses a document on the file system and then where the text within that document is parsed and words and phases are extracted from that text to form a new training list or add to an existing training list;
a method where the teacher may modify the lesson by changing individual text items (add/delete/reorder/change) that has been imported from the said above steps; and
a method to save the lesson under a lesson name.

20. A method according to [claim 1] where any of the lessons in the reading tutor may be modified by the parent or teacher, comprising:
a method where the teacher can specify and manipulate the order in which the training text items within a nominated lesson will be presented to the child;
a method where the teacher can remove training text items from a nominated lesson so they will not be presented to the child;
a method where the teacher may associate hints against specific training text instances in a nominated lesson in the format of an image, sound effect, voice recording or multimedia presentation with any of the training words in the list; and
a method to save the lesson.

21. A method of claim [claim 1] where the parent or teacher may make changes to any specified lesson and further comprising;
the teacher or parent may make those changes visible and effective for all children using the reading tutor;
the teacher or parent may make those changes visible and effective for a selected subset children using the reading tutor; and
the teacher or parent may make those changes visible and effective for specific groups of children using the reading tutor.

22. A method according to [claim 1] further comprising:
the teacher or parent can initiate a report of the child's session or an aggregate of more than one session, and a report is generated which provides the training words attempted by the child, with a corresponding visual indication of the child's understanding of each training text x, Q(c,x) against each training text item x;
the formatting of said reports into a series of flash cards that may be cut out from the printed report with scissors and trained with the child, where each flash card comprises of the word or text x with a visual indication of the past aggregate comprehension Q(c, x) of the child c;
the said series of flash cards, the inclusion of words and phrases that the child has not been trained with in the current lesson, or words and phrases which are to be used for training in lessons which are due in the near term, and then printing the words and phrases with a visual indication that these words or phases have not been trained but will be trained presently, and these words and phrases may facilitate offline “pre learning”; and
the inclusion of instructions on the report aimed at informing parents the most effective way in which in which to utilize the flash cards in training their child.

23. A method according to [claim 1] where the teacher or parent can initiate a report that summarizes the progress of a selected group of children who have used the reading tutor and for each child providing summary information comprising;
the child's name;
the average comprehension values of all words attempted by the child, which is an average of the Q(x, c) values for all values of x which have been trained to the child c by the reading tutor;
the sequential lesson number the child is up to;
the number of words mastered by the child; a word x is considered mastered if its corresponding Q(c, x) is greater than a constant threshold; and
how many times words have been trained with the child, including repeat presentations of the same word, and this corresponds to the number of training cycles.

24. A method for multiple choice selection method comprising:
providing a plurality of option choices where there is one correct answer and at least one incorrect answer in the options;
providing means for the user to choose any of those options;
if the user selects an incorrect option changing the display properties of the incorrect option to provide visual and aural feedback that it was the incorrect option chosen, and then after a pause, removing the incorrect option so the other options remain;
if the user fails to make a choice after a period of time then a hint providing a clue pertaining to the correct option is to be presented to the user, then if a subsequent period of inactivity follows subsequent hints are presented to the user if available;
if the user fails to make a choice after a period of time, and all of the hint strategies available as described in the prior step have been exhausted, then an incorrect option is removed, and then if a user fails to make a choice after subsequent periods further incorrect options are removed (if available) in turn until all incorrect options are removed and only the correct option remaining is displayed;
if the user selects a correct option changing the display properties of the correct option to provide visual reinforcement that it was the correct option chosen, and providing visual and/or aural feedback reinforcing the correct option, and then after a pause continuing to the final step, as described next; and
saving a progress record which can be retrieved at a later stage comprising information including an identifier uniquely describing the question asked, an identifier identifying the child, the incorrect options that were chosen (if any), and the hints that were provided before the correct option was chosen, and the time taken before the correct option was chosen.

25. A method of according to [claim 24] further comprising:
the options are a series of clickable buttons;
the label on each button is either the correct answer or one of the incorrect answers;
the relative proximal ordering of the buttons is random such that the correct option has an equal chance of appearing in any relative position within the series of buttons,
and when the incorrect option is clicked, the button display style is changed to represent a incorrect choice;
when the incorrect option is clicked, a sound is played through the sound device to indicate an incorrect choice;
when an incorrect choice is made, after a delay of between 0 to 10 seconds, that incorrect choice is removed from the display;
when the correct option is clicked the button display style is changed to communicate that a correct choice was made; and
when a correct option is chosen the word is said aloud through the sound device.

26. A method according to [claim 24] where the said first hint is a visual representation of the first letter of the correct answer, the second hint is a visual representation is the first two letters of the correct answer, and the nth hint is the first n letters of the correct answer where n is less than or equal to the number of letters comprising the correct answer.
